(19) United States
(12) Patent Application Publication
(10) Pub. No.: US 2026/0359886 A1
(43) Pub. Date: Nov. 12, 2026

(54) TAP TO RENT

(71) Applicant: Wells Fargo Bank, N.A., San Francisco, CA (US)

(72) Inventors: Susmitha Ganagoni, South Plainfield, NJ (US); Hendrik Sebastian Gores, Norwalk, CT (US); Christopher Ryan Reed, Davidson, NC (US); Daniel Sanford, Charlotte, NC (US)

(21) Appl. No.: 19/202,370

(22) Filed: May 8, 2025

(51) Int. Cl. G06Q 30/0645; G06Q 20/10; G06Q 20/32; G06Q 20/36; G06Q 20/40

(52) U.S. Cl. CPC G06Q 30/0645; G06Q 20/108; G06Q 20/3278; G06Q 20/36; G06Q 20/40; G06Q 20/401

(57) ABSTRACT

Systems and techniques may generally be used to execute a lease application in a tap to rent environment. An example technique may receive, at a wallet management system, from a first mobile wallet application, lessor credentials, and a request for lessee information for completing a lease application corresponding to a physical rental space, authenticating the lessor based on the lessor credentials, obtaining, from a data storage, rental space information of the physical rental space, verifying that the physical rental space is owned by the lessor based on the rental space information, retrieving, in response to authenticating the lessor and verifying that the physical rental space is owned by the lessor, the lessee information from a second mobile wallet application, auto-populating the lease application with the lessee information; and sending, to the first mobile wallet application, the auto-populated lease application.

### BACKGROUND

Entering into a lease agreement presents challenges for both lessors and lessees. A lessor needs, for example, to do a tenant screening (e.g., verifying the creditworthiness of the applicant, employment, rental history), a rental income estimation to ensure the lease is financially viable, a compliance with regulations check (e.g., ensuring the applicant complies with local, state, and federal regulations, such as fair housing laws), a security deposit requirements determination (e.g., determining the amount of the security deposit and ensuring it is reasonable and compliant with local regulations), or a lease agreement terms determination (e.g., drafting and reviewing the lease application to ensure it includes all necessary terms and conditions). On the other hand, a lessee needs, for example, to do a creditworthiness evaluation (e.g., providing proof of income, credit history, and rental history to demonstrate creditworthiness), demonstrate the ability to afford the rent and utilities, show a rent payment history (e.g., providing a proof of stable rent payment history), or an employment verification (e.g., show proof of employment status and income).

### BRIEF DESCRIPTION OF THE SEVERAL VIEWS OF THE DRAWINGS

FIG. 1 is a schematic diagram of elements of a tap to rent system, according to various examples.

FIG. 2 is a diagram showing a workflow that may be executed, for example, in the environment of FIG. 1, according to various examples.

FIG. 3 is a diagram showing a workflow that may be executed, for example, in the environment of FIG. 1, according to various examples.

FIG. 4 illustrates an example machine learning model, in accordance with some examples.

FIG. 5 illustrates a flowchart including techniques for executing a lease application, for example, in the environment of FIG. 1, according to various examples.

FIG. 6 illustrates a flowchart including techniques for executing a lease contract, for example, in the environment of FIG. 1, according to various examples.

FIG. 7 is a block diagram illustrating a machine in the example form of a computer system, within which a set or sequence of instructions may be executed to cause the machine to perform any one or more of the techniques discussed herein, according to various examples.

### DETAILED DESCRIPTION

The systems and techniques described herein may be used for automatically verifying security of a transaction, such as a lease signing. Security verification may include automatic verification of information (e.g., verifying the accuracy of the information of the lessee, such as income, employment, and rental history), credit score evaluation (e.g., evaluating the credit score of the lessee to assess creditworthiness), background check (e.g., conducting a background check to verify the identity and rental history of the lessee), or ensuring the lessee provides all required documentation, such as identification, proof of income, or rental history. The systems and techniques described herein may be used for securely facilitating payments of a lease contract.

A financial institution may facilitate a lease application between a lessor (e.g., landlord, property owner) and a lessee using a tap to rent technology. The tap to rent technology may involve a near field communication (NFC) between a lessor device and a lessee device. The lessor device or the lessee device may include a mobile device, a computer device, a smartwatch, a tablet, a terminal, a point of sale (POS) terminal, or the like. The lessor or the lessee may be customers of the financial institution. For example, a technique may include a lessor sending a lease application to a lessee and receiving the lease application including the lessee information. The systems and techniques described herein improve lessor and lessee experience by making the lease application interaction between the lessor and the lessee seamless. The system and techniques described herein may, upon a tap between the device of the lessor and the device of the lessee, automatically verify the lessor and lessee information and identity, verify the ability of the lessee to afford the rent, execute the lease application and lease contract, guarantee the payment of the lease contract, or make the payment for lease transactions related to the lease contract.

In an example, a financial institution may collect lessor information and lessee information from onboarding applications. The financial institution may access credit score information of the lessee for a credit score evaluation. The financial institution may have the lessee rental history information from a previous lease application through the financial institution or via permission granted by the lessee to access the information at another source. The financial institution may have registered information on a physical rental space. The financial institution may use the registered information on a physical rental space to verify ownership (e.g., verify that the lessor owns the physical rental space).

The financial institution may put on hold funds of a demand deposit account (DDA) or other account of the lessee to guarantee the payment of the lease contract (e.g., put on hold money as a security deposit). The financial institution may execute a microloan (e.g., a small loan with a short repayment period) or a revolving loan to the lessee for payment of the lease contract. In an example, the lessee may have funds available for payment of the lease contract. In this example, the lessee may be given a microloan and use the microloan to pay the lease contract and use the available funds to pay the microloan for the purpose of building credit.

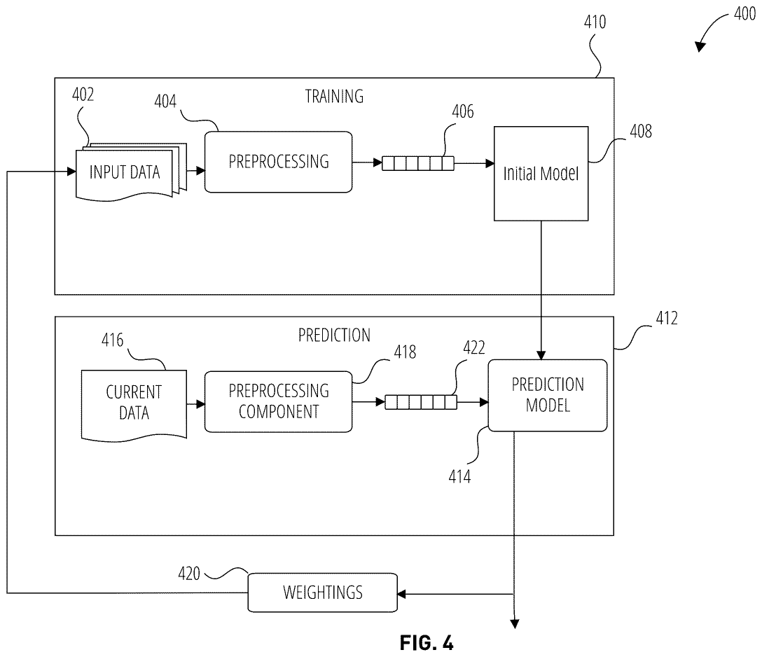

The financial institution may use a machine learning model, as shown in FIG. 4, to assess the lessor information and the lessee information and make a decision on the lease application (e.g., whether to approve or deny the lease application). In an example, the financial institution may assess the lease application and send a recommendation to the lessor device. In other examples, the financial institution may assess the lease application and send a context to the lessor device. The context may include a summary for example with one or more key points for the lessor to consider before making a final decision on the lease application. The one or more key points may include personal information of the lessee, financial overview of the lessee, rental history of the lessee, background check information of the lessee, pet and lifestyle information, lease terms, or the like.

The lessor device may, using a trained machine learning model (e.g., machine learning component 400, shown in FIG. 4), determine whether to approve the lease application. The lessor may be able to determine whether to approve the lease application based on the context received from the financial institution.

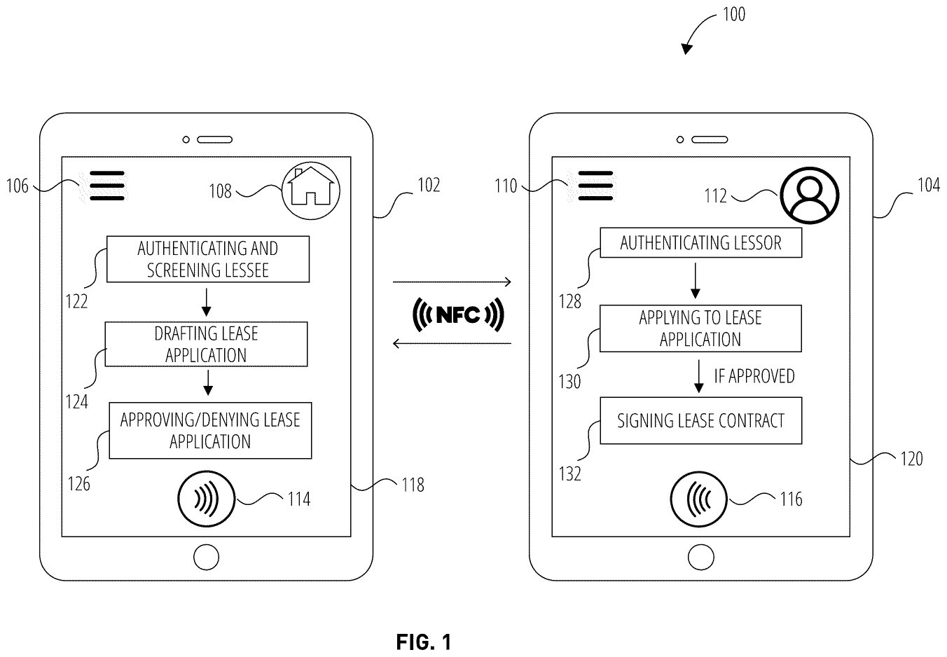

FIG. 1 illustrates a tap to rent system 100 including a graphical user interface (GUI) 118 on a lessor device 102 and a GUI 120 on a lessee device 104, according to some examples. The GUI 118 includes various user interface components, such as a lessor profile 108, actions to be taken 122, 124, or 126, a contactless indicator 114, and a menu 106. The GUI 120 includes various user interface components, such as a lessee profile 112, a contactless indicator 116, actions to be taken 128, 130, or 132, and a menu 110.

In various examples, a prospective lessee may use the tap to rent system 100 described herein to start a lease application and, upon approval of the lease application, sign a lease contract for the physical rental property.

A wallet application of a financial institution may be displayed on the GUI 118 of the lessor device 102 or on the GUI 120 of the lessee device 104, as shown in FIG. 1. The wallet application may include a menu 106 of services to the lessor (e.g., visualizing lessee applications, registering properties for leasing) and a menu 110 of services to the lessee (e.g., lease application status search, applying for a loan). In an example, the lessor or the lessee are customers of the financial institution. The lessor profile 108 may be accessed from the GUI 118 and the lessee profile 112 may be accessed from the GUI 120. The lessor profile 108 may be associated with lessor credentials (e.g., proof of address, proof of identity, biometric data (e.g. fingerprints, facial recognition), public key infrastructure (PKI) certificates, smart card credentials, one-time passwords (OTP), two-factor authentication (2FA) codes, token credentials, blockchain-based credentials (e.g. self-sovereign identity)). The lessee profile 112 may be associated with lessee credentials (e.g., proof of address, proof of identity, a one-time password, a personal identifier number (PIN), token credentials, biometric data, or the like).

The lessor may authenticate and screen the lessee 122 through the wallet application of the financial institution by using Near Field Communication (NFC) circuitry to wirelessly exchange data between the lessor device 102 and the lessee device 104. Screening the lessee 122 may include verifying the accuracy of the information of the lessee, such as income, employment, or rental history, making a credit score evaluation to assess creditworthiness, performing a background check to verify the identity and rental history of the lessee, determining whether the lessee provided the required documentation, such as identification, proof of income, or rental history, or the like. Authenticate the lessee 122 may include requesting, via the wallet application on the lessee device 104, that the lessee enter a password to confirm personal information (e.g., telephone, e-mail, address, date of birth), type a one-time password (OTP) received by short message service (SMS), or the like. The wallet application may draft the terms of a lease application for the physical rental property 124, authenticate the lessor 128 (e.g., ascertain that the lessor owns the physical rental property, verify the identity of the lessor), or start the lease application 130.

The wallet application may, for example, using a trained learning machine model (e.g., machine learning component 700, as shown in FIG. 4), make an assessment of lessor data and lessee data for determining whether to approve or deny the lease application 126. In an example, the wallet application determines whether to approve or deny the lease application and sends a recommendation to the lessor. In another example, the wallet application determines whether to approve or deny the lease application and automatically approves or denies the lease application based on the determination. A notification may be sent to the lessor device 102 or the lessee device 104. In some examples, the wallet application may request additional information from the lessor or lessee. In case the lease application is approved (e.g., by the lessor or automatically by the wallet application on lessor device 102), the wallet application on the lessee device 104 may apply a signature of the lessee to a lease contract 132 corresponding to the lease application. Applying the signature of the lessee may include requesting the signature of the lessee, requesting a confirmation from the lessee to enter the lease contract, or the like.

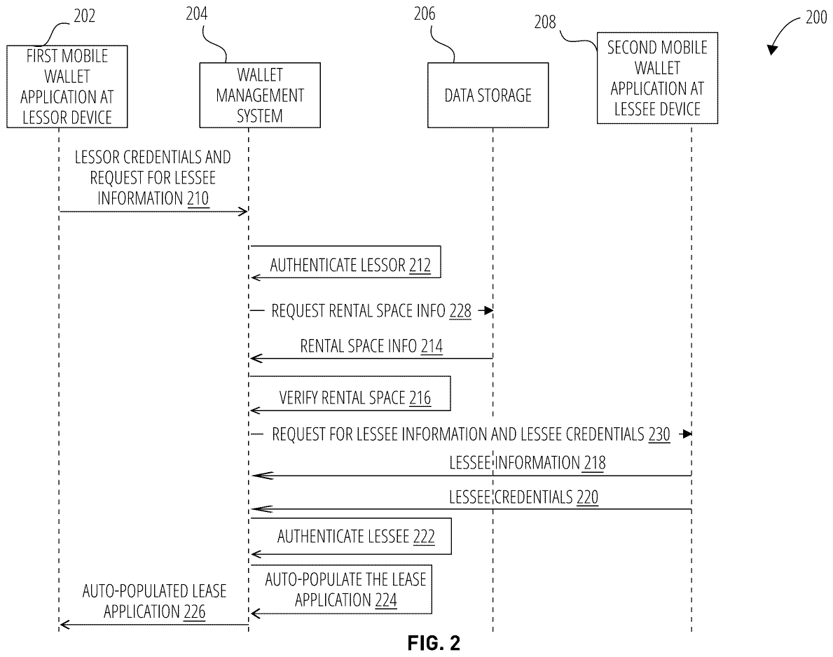

FIG. 2 is a diagram showing a workflow 200 that may be executed, for example, in the environment of FIG. 1, for executing a lease application, according to various examples. FIG. 2 includes a first mobile wallet application 202, a wallet management system (WMS) 204, a data storage 206, and a second mobile wallet application 208.

In various examples, the first mobile wallet application 202 is executed in the lessor device (e.g., lessor device 102) and the second mobile wallet application 208 is executed in the lessee device (e.g., lessee device 104). In an example, a lessor and a prospective lessee initiate interaction between the first mobile wallet application 202 and the second mobile wallet application 208 by tapping the respective devices. By tapping (e.g., touching or bringing to a short distance proximity, such as 4 cm or less) the lessor device with the lessee device, the devices may initiate a connection via Near Field Communication (NFC) technology.

The WMS 204 may be a core backend system that handles all wallet-related operations in a digital platform. The WMS 204 may be responsible for creating, managing, and securing wallet applications, processing transactions (e.g., deposits, withdrawals, and transfers), and maintaining accurate balances and transaction histories.

In various examples, the WMS 204 uses user permissions to control access to wallet application features and actions based on roles or privileges. For example, regular users may be allowed to view balances, make deposits, or transfer funds, while admins or agents can approve withdrawals, freeze wallets, or manage disputes. Permissions may be defined in roles (e.g., user, admin, auditor) and enforced through an authentication system using tokens or session data. The use of user permissions ensures that only authorized users can perform sensitive operations, helping maintain security, compliance, and trust within the system.

In other examples, a user (e.g., the lessor, the lessee) may provide permissions to the WMS 204 by explicitly granting access during account setup, app installation, or when connecting third-party services. Providing permission may include agreeing to terms and conditions, selecting permission scopes (e.g., “view balance,” “initiate transfers”), authorizing access via OAuth or API keys, or the like. In an example, users (e.g., the lessor, the lessee) may manage permissions through a dashboard, choosing which apps or roles have access to specific wallet functions. These permissions are securely stored and enforced by the WMS 204 to control what each user or service is allowed to do.

The WMS 204 may manage wallet applications (e.g., first mobile wallet application 202, second mobile wallet application 208) through secure Application Programming Interfaces (APIs). The wallet applications may interact with the WMS 204 to request wallet data or perform actions. In various examples, the WMS 204 ensures all operations are authorized, validated, and processed safely using real-time data updates, transaction logging, and concurrency controls. WMS 204 acts as the single source of truth, keeping wallet applications in sync and ensuring consistent, reliable financial operations across the entire ecosystem.

In various examples, the WMS 204 manages the interaction between the first mobile wallet application 202 and the second mobile wallet application 208. The WMS 204 may be located on a server of a financial institution.

In an example, the wallet management system (WMS) 204 receives from the first mobile wallet application 202 lessor credentials of a lessor and a request for lessee information 210 of a prospective lessee of a physical rental property. The WMS 204 may authenticate the lessor (e.g., verify identity of the lessor) based on the lessor credentials. The lessor credentials may include proof of address, proof of identity, biometric data (e.g. fingerprints, facial recognition), public key infrastructure (PKI) certificates, smart card credentials, one-time passwords (OTP), two-factor authentication (2FA) codes, token credentials, blockchain-based credentials (e.g. self-sovereign identity), or the like.

The WMS 204 may authenticate the lessor 212 to ensure secure access to wallet features and transactions. The WMS 204 may authenticate the lessor 212 based on the lessor credentials 210, for example, a username and a password, optionally combined with two-factor authentication (2FA) for added security. The WMS 204 may use biometric authentication (e.g., fingerprint or facial recognition) in the first mobile wallet application 202 to authenticate the lessor 212. The WMS may use OAuth tokens or digital signatures to verify the lessor identity during sensitive actions like transfers or withdrawals. Once the lessor is authenticated, the WMS 204 may issue a session or an access token that allows the lessor to interact securely with the first mobile wallet application 202.

The WMS 204 may request rental space information 228 from the data storage 206. The WMS 204 may retrieve (e.g., receive, obtain, capture) rental space information 214 of the physical rental property from the data storage 206. The data storage 206 may include random-access memory (RAM), cache, hard drive, cloud, or the like. The data storage 206 may be maintained by the financial institution or another enterprise. The rental space information may correspond to information collected during registration of the physical rental space at the financial institution and stored at the data storage 206. The rental space information may include ownership historical data, physical address, property description, lot number, size, lien records, easements and restrictions, legal issues, or the like. The WMS 204 may verify rental space 216 based on lessor credentials 210 and rental space information 214.

The WMS 204 may verify the rental space by integrating with listing platforms or property management systems to verify that the rental space meets the required conditions before processing payments or generating lease applications. Verifying the rental space 216 may include checking the space availability, verifying ownership or registration details, confirming pricing terms, ensuring compliance with platform rules, or the like. Once the rental space is verified, the WMS 204 may link the rental space to a wallet (e.g., the first mobile wallet application) for deposits, rent payments, and refunds—enabling secure, automated financial transactions tied directly to the verified rental space.

In various examples, the WMS 204 may request lessee information and lessee credentials 230 from the second mobile wallet application 208. The WMS 204 may retrieve (e.g., obtain, receive, capture, collect) the lessee information 218 from the second mobile wallet application 208, in response to authenticating the lessor 212 and verifying ownership of the physical rental property 216. In an example the WMS 204 may send a request for the lessee information and the lessee credential to the second mobile wallet application, in response to authenticating the lessor 212 and verifying ownership of the physical rental property 216. The lessee information 218 may include full name, address, date of birth, marital status, identity number, proof of income, or the like.

The WMS 204 may receive (e.g., retrieve, obtain, collect) lessee credentials 220 from the second mobile wallet application 208. The WMS 204 may authenticate lessee 222 based on the lessee credentials 220. The lessee credentials 220 may include proof of address, proof of identity, a one-time password, a personal identifier number (PIN), token credentials, biometric data, or the like.

The WMS 204 may auto-populate the lease application 224 using the lessee information 218 and send the auto-populated lease application 226 to the first mobile wallet application 202. The WMS 204 may auto-populate the lease application by automatically inserting relevant wallet and user information (e.g., lessee information 218) into a predefined lease application template. In an example, when the lease application is initiated, the WMS 204 pulls data like the lessee name, wallet ID, current balance, and transaction history. The WMS 204 then may fill in placeholders in the lease application template (e.g., payment terms, security deposit, dates) using this information. The completed lease application may be generated as a PDF or digital document, ready for review and e-signature. The process of auto-populating the lease application by the WMS 204 ensures accuracy, saves time, and creates a seamless user experience.

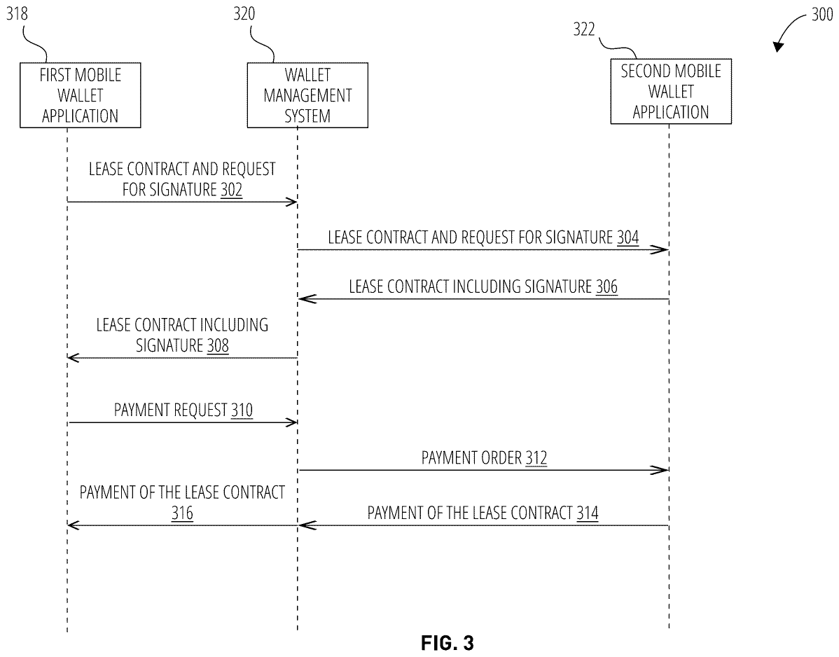

FIG. 3 is a diagram showing a workflow 300 that may be executed, for example, in the environment of FIG. 1, for executing a lease contract and payment of the executed lease contract, according to various examples. FIG. 3 includes a first mobile wallet application 318, a second mobile wallet application 322, and a wallet management system 320.

The first mobile wallet application 318 may be executed in a device of a lessor (e.g., lessor device 102), and the second mobile wallet application 322 may be executed in the device of a lessee (e.g., lessee device 104).

The wallet management system 320 may receive a lease contract and a request for a lessee signature of the lessee 302. The lease contract may correspond to a lease application for which the lessee was approved. The wallet management system 320 may forward the lease contract along with the request for the lessee signature 304 to the second mobile wallet application 322.

The second mobile wallet application 322 may apply the lessee signature in the lease contract and send, via the wallet management system 320, the signed lease contract 306, 308 to the first mobile wallet application 318. Applying the signature of the lessee may include requesting the signature of the lessee, requesting a confirmation from the lessee to enter the lease contract, or the like.

In various examples, once the lessor and lessee enter the lease contract, the tap to rent system 100 may be used to collect payment for lease transactions related to the lease contract. The wallet management system 320 may receive a payment request 310 from the first mobile wallet application 318. In various examples, the wallet management system 320 assesses a payment type for the payment request 310. The wallet management system 320 may determine that the payment request 310 corresponds to a lease transaction, and, in response to determining that the payment request 310 corresponds to the lease transaction, the wallet management system 320 may execute the payment. Executing the payment may include sending a payment order 312 to disburse funds of a demand deposit account (DDA) of the lessee, corresponding to a payment of the lease contract 314, 316, to the first mobile wallet application 318. The DDA of the lessee may be linked to the wallet management system 320.

In an example, executing the payment may include sending a payment order 312 to disburse cryptocurrency funds from the second mobile wallet application 322 and depositing into the first mobile wallet application 318. Executing the payment may include sending a payment order 312 to generate a microloan for the lessee from a financial institution controlling the wallet management system 320. The microloan may be used for the payment of the lease contract 314, 316.

In an example, the lessee may have funds available in a DDA account to pay for the lease contract, and a microloan may be established to build the credit score of the lessee. In this example, the wallet management system 320 may send an order to the second mobile wallet application 322 to pay off the microloan using funds from the DDA of the lessee.

FIG. 4 illustrates an example machine learning component for training and execution related to a tap-to-rent system, according to various examples. The machine learning component 400 may be deployed to execute on a computing device (e.g., a mobile phone, a tablet, a laptop, a personal computer). The machine learning component 400 may adhere to data protection regulations and privacy laws while sourcing and processing information. The machine learning component 400 may evaluate the accuracy, reliability, and completeness of obtained data.

Machine learning component 400 uses a training component 410 and a prediction component 412. Training component 410 uses input data 402, for example, after going preprocessing component 404 (e.g., cleaning and formatting the data to ensure consistency and remove irrelevant information) to determine the feature vector 406 including one or more features. The feature vector 406, including one or more features, may be used to generate an initial model 408 (e.g., a deep neural network or ensemble method), which may be updated iteratively or with future labeled or unlabeled data (e.g., during reinforcement learning), for example, to improve the performance of the prediction component 412 or the initial model 408. An improved model may be redeployed for use. The input data 402 may be labeled to indicate whether the data is related to the lease application (e.g., lessor information, lessee information, or physical rental property information) or not related to the lease application.

The input data 402 may include a large dataset of lessee data, including both legitimate lessees and known fraudulent lessees. The input data 402 may include a large dataset of lessor data, including both legitimate lessors and known fraudulent lessors. The input data 402 may include a large dataset of physical rental properties, including, for each property, ownership historical data, physical address, property description, lot number, size, lien records, easements and restrictions, legal issues, or the like. The current data 416 may include, for the current lease application, physical rental space information, lessor information, lessor credentials, lessee information, lessee credentials, or the like. The input data 402 may be obtained (e.g., received, retrieved, downloaded, or imported) from a public database, a private database, a third-party database, internal systems, a cloud storage service, or the like.

The preprocessing component 404 may clean and standardize the input data 402 to ensure consistency (e.g., convert varied data structures into a consistent format for easier comparison and analysis). The preprocessing component 418 may remove any personally identifiable information to comply with privacy regulations. The preprocessing component 404 may determine the feature vector 406 including one or more features that may indicate whether the lease application should be approved or denied.

The initial model 408 may be trained using labeled data indicating whether the data is related to the lease application (e.g., lessor information, lessee information, or physical rental property information) or not related to the lease application. The initial model 408 may be trained using labeled lease application data indicating the outcome (e.g., approved or rejected). The initial model 408 may implement anomaly detection algorithms to identify unusual patterns that may not be present in the labeled data. The initial model 408 may be validated and tested by evaluating the initial model 408 performance on a separate dataset to ensure the accuracy and generalization capabilities.

The initial model 408 may be retrained using weightings 420 (e.g., confirmed cases of approved and rejected lease applications). The initial model 408 may be updated using further input data 402 until a satisfactory model 414 is generated. The prediction model 414 generation may be stopped according to a specified criteria (e.g., after sufficient input data 402 is used, such as 1,000, 10,000, 100,000 data points, etc.) or when data converges (e.g., similar inputs produce similar outputs).

The specific machine learning algorithm used for the training component 410 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), or Chi-squared Automatic Interaction Detector (CHAID)), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training component 410. In an example embodiment, a regression model is used and the prediction model 414 is a vector of coefficients corresponding to a learned importance for each of the features in the feature vector 406, 422. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

In the prediction component 412, the current data 416 may be input to preprocessing component 418. In some examples, preprocessing component 418 and preprocessing component 404 are the same. The prediction component 412 produces feature vector 422 from the preprocessed current data 416, which is input into the prediction model 414 to generate one or more criteria weightings 420. The prediction model 414 may recognize and link related information about a lessor, a lessee, or a physical rental space across different data sources.

The prediction model 414 may use context and additional data points to differentiate between similar entities. The prediction model 414 may generate unified views of each lessor, lessee, and physical rental space by combining information from a plurality of data sources.

The criteria weightings 420 may be used to output a prediction, as discussed further below. Criteria weightings 420 may refer to the relative importance assigned to different features in the decision-making process of the machine learning component 400. In an example, the criteria weightings 420 may include a high weight to transaction patterns (e.g., unusual frequency, timing, or amounts of lease) and behavioral anomalies (e.g., sudden changes in leasing patterns), medium-high weight to account history (e.g., past suspicious activities) and network connections (e.g., links to known suspicious entities or individuals), and medium weight to customer profile (e.g., occupation, income level, risk rating) and geographic factors (e.g., high-risk locations involved in leases). The criteria weightings 420 may be determined during the training and fine-tuning process, using techniques like feature importance analysis or regularization methods. The criteria weightings 420 may be adjusted iteratively to optimize the performance of the machine learning component 400 in accurately identifying when a lease application should be approved or denied while minimizing false positives.

In an example, a lessor profile may be generated using the machine learning component 400 trained with input data 402 associated with the lessor obtained from at least one of past lease contracts of the lessor, public records, or onboarding information.

The training component 410 may operate in an offline manner to train the prediction model 414 (e.g., on a server). The prediction component 412 may be designed to operate in an online manner (e.g., in real-time, on a mobile device, or on a wearable device). In some examples, the prediction model 414 may be periodically updated via additional training (e.g., via updated lease application data), based on labeled or unlabeled output data in the criteria weightings 420, based on identified future data, such as by using reinforcement learning to personalize a general model (e.g., the initial model 408) to a particular use.

Once trained, the prediction model 414 may output a prediction, such as an indication to approve or deny the lease application. The output of the machine learning component 400 may include a risk score for a lease application (e.g., a numerical value indicating the overall likelihood of the lease application being problematic). The output may include a list of flagged leases (e.g., a list of specific leases that the machine learning component 400 identified as potentially suspicious, including details such as date, address, and parties involved). The output may include a representation (e.g., visual or textual) of connections of the lessor, lessee, or rental space to other potentially suspicious lease contracts or known problematic lease contracts. The output may include a detailed rationale for a lessor or a lessee to be considered suspicious. The output may include recommended actions (e.g., a suggestion for implementing further investigation based on the identified risks, approving or denying the lease application).

The prediction model 414 may be for the entire system (e.g., built of input data accumulated throughout the entire system, regardless of the lease application being made) or may be built specifically for a lease application or a lease application group. In an example, the lease application group includes one or more leases having similar characteristics (e.g., same lessor, same lessee, geographic location, rental space size, or the like).

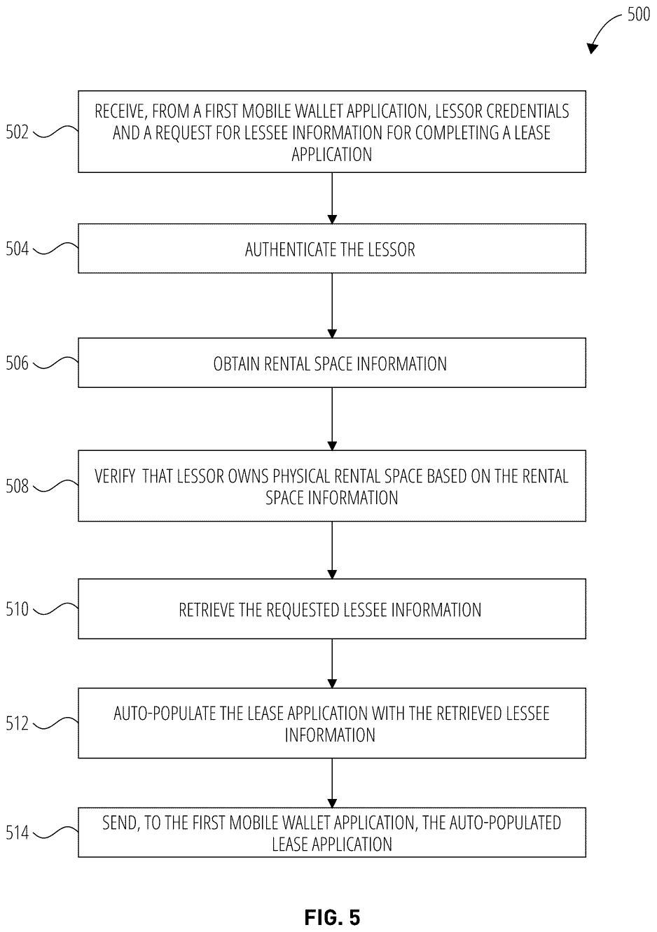

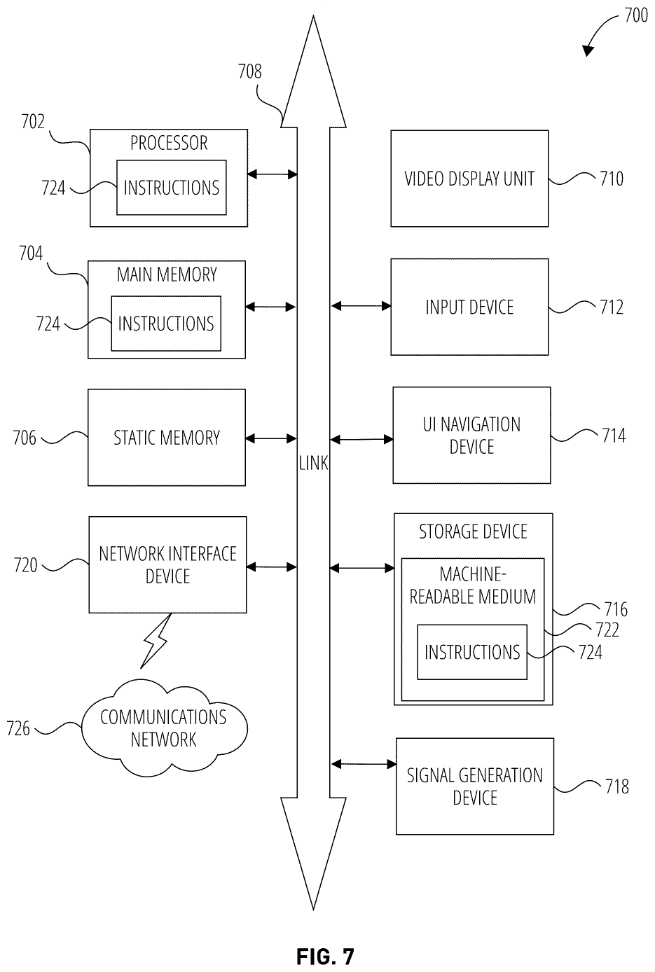

FIG. 5 is a flowchart illustrating a technique 500, according to various examples. In an example, operations of technique 500 may be performed by processing circuitry, for example, by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 7.

The technique 500 may include an operation 502 to receive, at a wallet management system, from a first mobile wallet application executed at a first mobile computing device of a lessor, lessor credentials of the lessor associated with a lease application, and a request for lessee information for completing the lease application. In an example, the lease application corresponds to a physical rental space. The first mobile wallet application may store a profile for the lessor including the lessor credentials. In an example, the profile is generated using a machine learning model trained with data associated with the lessor obtained from at least one of past lease contracts of the lessor, public records, or onboarding information.

The technique 500 may include an operation 504 to authenticate, using the wallet management system, the lessor based on the lessor credentials.

The technique 500 may include an operation 506 to obtain, from a data storage, rental space information of the physical rental space. The rental space information may correspond to information collected during a registration of the physical rental space at a financial institution and stored at the data storage.

The technique 500 may include an operation 508 to verify, using the wallet management system, that the physical rental space is owned by the lessor based on the rental space information.

The technique 500 may include an operation 510 to retrieve, in response to authenticating the lessor and verifying that the physical rental space is owned by the lessor, the lessee information from a second mobile wallet application executed at a second mobile computing device of the lessee.

The technique 500 may include an operation 512 to auto-populate the lease application with the lessee information. In an example, technique 500 includes an operation to, before the lease application is auto-populated, receive, at the wallet management system, from the second mobile wallet application, lessee credentials for authentication and authenticate the lessee based on the lessee credentials. The lessee credentials may include at least one of a one-time password, a personal identifier number (PIN), or a biometric feature.

The technique 500 may include an operation 514 to send, to the first mobile wallet application, the auto-populated lease application.

In an example, technique 500 includes an operation to receive, at the wallet management system, from the first mobile wallet application, a signature request for a signature of the lessee in a lease contract corresponding to the lease application. Technique 500 may include an operation to send the signature request to the second mobile wallet application, receive, in response to the signature request, the lease contract including the signature of the lessee from the second mobile wallet application, and send the lease contract including the signature of the lessee to the first mobile wallet application.

The technique 300 may include an operation to receive, at the wallet management system, from the first mobile wallet application, a payment request for the lease contract. The technique 300 may include an operation to identify, at the wallet management system, that the payment request corresponds to a lease transaction. The technique 500 may include an operation to disburse, in response to the identification of the payment request as the lease transaction, funds of a demand deposit account (DDA) of the lessee to the first mobile wallet application. The disbursed funds correspond, for example, to a payment of the lease contract.

In an example, the DDA is linked to the wallet management system. The technique 500 may include an operation to disburse, in response to the identification of the payment request as the lease transaction, cryptocurrency from the second mobile wallet application to the first mobile wallet application. The cryptocurrency disbursement may correspond to the payment of the lease contract. In response to the identification of the payment request as the lease transaction, technique 500 may include an operation to establish a microloan for the lessee from a financial institution controlling the wallet management system. The microloan may be used for the payment of the lease contract.

In an example, the lessee has funds available in a DDA account, but the microloan is established to build the credit score of the lessee. In this scenario, technique 500 may include an operation to, using the wallet management system, pay off the microloan with funds of the DDA of the lessee. The DDA may be linked to the wallet management system.

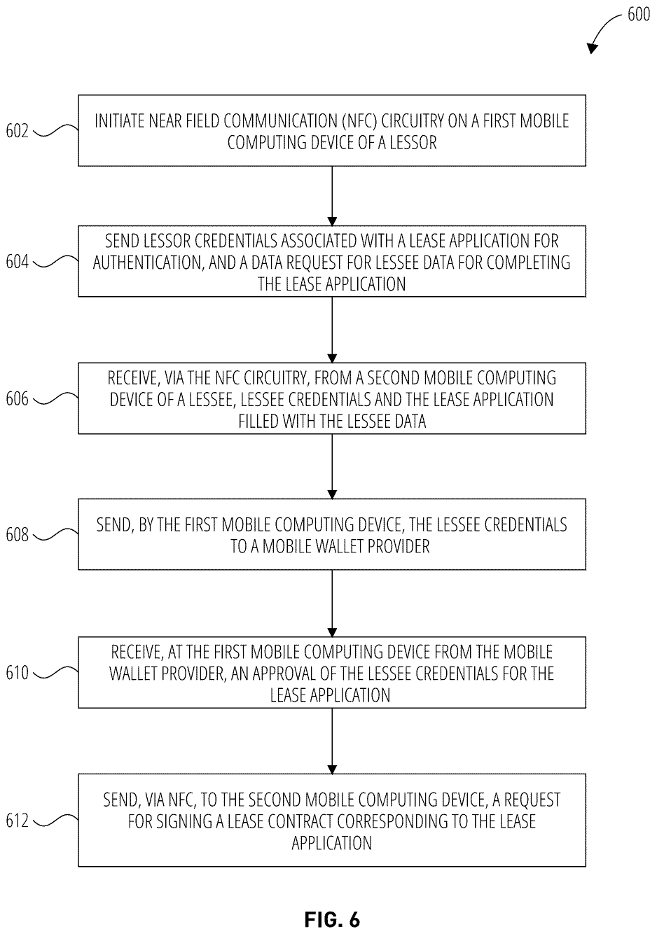

FIG. 6 is a flowchart illustrating a technique 600, according to various examples. In an example, operations of technique 600 may be performed by processing circuitry, for example, by executing instructions stored in memory. The processing circuitry may include a processor, a system on a chip, or other circuitry (e.g., wiring). For example, technique 600 may be performed by processing circuitry of a device (or one or more hardware or software components thereof), such as those illustrated and described with reference to FIG. 7.

The technique 600 may include an operation 602 to initiate a near field communication (NFC) circuitry on a first mobile computing device of a lessor, the first mobile computing device including a first mobile wallet application.

The technique 600 may include an operation 604 to send lessor credentials of the lessor associated with a lease application for authentication and a data request for lessee data for completing the lease application to a second mobile computing device of a lessee. The lease application may correspond to a physical rental space. The technique 600 may include an operation to generate, using a machine learning model, a profile for the lessor including the lessor credentials. The machine learning model may be trained with data associated with the lessor obtained from at least one of past lease contracts of the lessor, public records, or onboarding information. The technique 600 may include an operation to store the profile for the lessor at the first mobile wallet application.

The technique 600 may include an operation 606 to receive, via the NFC circuitry, from the second mobile computing device, lessee credentials of the lessee and the lease application filled with the lessee data.

The technique 600 may include an operation 608 to send, by the first mobile computing device, the lessee credentials to a mobile wallet provider associated with the first mobile wallet application. The lessee credentials may include a one-time password, a personal identifier number (PIN), a biometric feature, or the like.

The technique 600 may include an operation 610 to receive, at the first mobile computing device from the mobile wallet provider, an approval of the lessee credentials for the lease application.

The technique 600 may include an operation 612 to send, in response to receiving the approval of the lessee credentials for the lease application, a request for signing a lease contract corresponding to the lease application to the second mobile computing device.

The technique 600 may include an operation to send, via the NFC circuitry, to the second mobile computing device, a payment request for the lease contract. In an example, the technique 600 includes an operation to receive, in response to the payment request, at the first mobile wallet application from a second mobile wallet application associated with the second mobile computing device: a cryptocurrency amount, a monetary value of a first demand deposit account (DDA) of the lessee, or funds of a microloan linked to the second mobile wallet application.

The WMS enables fund transfers between user accounts (e.g., the first demand deposit account (DDA) of the lessee and a lessor account linked to the first mobile wallet application) by securely managing the transaction through wallet applications (e.g., the first mobile wallet application and the second wallet application). In various examples, when a user initiates a transfer in the app, the WMS verifies the sender identity, checks for sufficient balance, and validates the recipient wallet. The WMS may then process the transfer by debiting the sender wallet (e.g., the second mobile wallet application) and crediting the recipient wallet (e.g., the first mobile wallet application) in a single operation, ensuring consistency and accuracy. The WMS may log the transaction and update both users in real time, allowing seamless peer-to-peer transfers within the platform.

The WMS may facilitate cryptocurrency transfers between the first mobile wallet application and the second mobile wallet application by interacting with an underlying blockchain network. For example, when the lessee initiates a crypto transfer, the WMS verifies the lessee identity and wallet balance, then creates and signs a blockchain transaction using a lessee private key (e.g., managed via secure custody solutions). The transaction may then be broadcast to the blockchain network. Once confirmed, the WMS may update both the lessee and lessor wallet records and notify the first mobile wallet application and the second mobile wallet application in real-time.

FIG. 7 is a block diagram illustrating a machine in the example form of computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client Network environments, or it may act as a peer machine in peer-to-peer (or distributed) Network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, or the like), a main memory 704, and a static memory 706, which communicate with each other via a link 708. The computer system 700 may further include a video display unit 710, an input device 712 (e.g., a keyboard), and a user interface (UI) navigation device 714 (e.g., a mouse).

In one embodiment, the video display unit 710, input device 712, and UI navigation device 714 are incorporated into a single device housing such as a touchscreen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, or other sensors.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, the static memory 706, and/or within the processor 702 during execution thereof by the computer system 700, with the main memory 704, the static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 722 that excluded transitory signals.

The instructions 724 may further be transmitted or received over a communications network 726 using a transmission medium via the network interface device 720 utilizing any one of a number of well-known transfer protocols (e.g., HTTP). Examples of communication networks include a Local Area Network (LAN), a Wide Area Network (WAN), the Internet, mobile telephone networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Example 1 is a method comprising: receiving, at a wallet management system, from a first mobile wallet application executed at a first mobile computing device of a lessor, lessor credentials of the lessor associated with a lease application, and a request for lessee information corresponding to a lessee for completing the lease application, the lease application corresponding to a physical rental space; authenticating, using the wallet management system, the lessor based on the lessor credentials; obtaining, from a data storage, rental space information of the physical rental space; verifying, using the wallet management system, that the physical rental space is owned by the lessor based on the rental space information; retrieving, in response to authenticating the lessor and verifying that the physical rental space is owned by the lessor, the lessee information from a second mobile wallet application executed at a second mobile computing device of the lessee; auto-populating the lease application with the lessee information; and sending, to the first mobile wallet application, the auto-populated lease application.

In Example 2, the subject matter of Example 1 includes, wherein the first mobile wallet application stores a profile for the lessor including the lessor credentials, the profile generated using a machine learning model trained with data associated with the lessor obtained from at least one of past lease contracts of the lessor, public records, or onboarding information.

In Example 3, the subject matter of Examples 1-2 includes, wherein the rental space information corresponds to information collected during a registration of the physical rental space at a financial institution and stored at the data storage.

In Example 4, the subject matter of Examples 1-3 includes, before auto-populating the lease application: receiving, at the wallet management system, from the second mobile wallet application, lessee credentials for authentication; and authenticating the lessee based on the lessee credentials.

In Example 5, the subject matter of Example 4 includes, wherein the lessee credentials include at least one of a one-time password, a personal identifier number (PIN), or a biometric feature.

In Example 6, the subject matter of Examples 1-5 includes, receiving, at the wallet management system, from the first mobile wallet application, a signature request for a signature of the lessee in a lease contract corresponding to the lease application and; sending the signature request to the second mobile wallet application; receiving the lease contract including the signature of the lessee from the second mobile wallet application; and sending the lease contract including the signature of the lessee to the first mobile wallet application.

In Example 7, the subject matter of Example 6 includes, receiving, at the wallet management system, from the first mobile wallet application, a payment request for the lease contract; identifying, at the wallet management system, that the payment request corresponds to a lease transaction; and in response to identifying that the payment request corresponds to the lease transaction, disbursing at least one of: funds of a demand deposit account (DDA) of the lessee to the first mobile wallet application, the DDA linked to the wallet management system, the funds corresponding to a payment of the lease contract; cryptocurrency, the cryptocurrency corresponding to the payment of the lease contract; or a microloan for the lessee from a financial institution corresponding to the wallet management system, the microloan corresponding to the payment of the lease contract.

In Example 8, the subject matter of Examples 6-7 includes, receiving, at the wallet management system, from the first mobile wallet application, a payment request for the lease contract; identifying, at the wallet management system, that the payment request corresponds to a lease transaction; and in response to identifying that the payment request corresponds to the lease transaction: establishing a microloan for the lessee at a financial institution, the microloan corresponding to a payment of the lease transaction; sending, using the wallet management system, funds of the microloan to an account of the lessor linked to the first mobile wallet application; and paying off the microloan with a demand deposit account (DDA) of the lessee for building credit score of the lessee, the DDA linked to the wallet management system.

Example 9 is a method comprising: initiating near field communication (NFC) circuitry on a first mobile computing device of a lessor, the first mobile computing device including a first mobile wallet application; sending lessor credentials of the lessor associated with a lease application for authentication and a data request for lessee data for completing the lease application; receiving, via the NFC circuitry, from a second mobile computing device of a lessee, lessee credentials of the lessee and the lease application filled with the lessee data; sending, by the first mobile computing device, the lessee credentials to a mobile wallet provider associated with the first mobile wallet application; receiving, at the first mobile computing device from the mobile wallet provider, an approval of the lessee credentials for the lease application; and sending, in response to receiving the approval of the lessee credentials for the lease application, a request for signing a lease contract corresponding to the lease application to the second mobile computing device.

In Example 10, the subject matter of Example 9 includes, sending, via the NFC circuitry, to the second mobile computing device, a payment request for the lease contract; and receiving, in response to the payment request, at the first mobile wallet application from a second mobile wallet application associated with the second mobile computing device: a cryptocurrency amount; a monetary value of a first demand deposit account (DDA) of the lessee; or funds of a microloan linked to the second mobile wallet application.

In Example 11, the subject matter of Examples 9-10 includes, wherein the lease application corresponds to a physical rental space.

In Example 12, the subject matter of Examples 9-11 includes, generating, using a machine learning model, a profile for the lessor including the lessor credentials, the machine learning model trained with data associated with the lessor obtained from at least one of past lease contracts of the lessor, public records, or onboarding information; and storing the profile for the lessor at the first mobile wallet application.

In Example 13, the subject matter of Examples 9-12 includes, wherein the lessee credentials include at least one of a one-time password, a personal identifier number (PIN), or a biometric feature.

Example 14 is a lease management system, the system comprising at least one processor; and memory including instructions that, when executed by the at least one processor, cause the at least one processor to perform operations to: receive, at a wallet management system, from a first mobile wallet application executed at a first mobile computing device of a lessor, lessor credentials of the lessor associated with a lease application, and a request for lessee information corresponding to a lessee for completing the lease application, the lease application corresponding to a physical rental space; authenticate, using the wallet management system, the lessor based on the lessor credentials; obtain, from a data storage, rental space information of the physical rental space; verify, using the wallet management system, that the physical rental space is owned by the lessor based on the rental space information; retrieve, in response to authenticating the lessor and verifying that the physical rental space is owned by the lessor, the lessee information from a second mobile wallet application executed at a second mobile computing device of the lessee; auto-populate the lease application with the lessee information; and send, to the first mobile wallet application, the auto-populated lease application.

In Example 15, the subject matter of Example 14 includes, wherein the first mobile wallet application stores a profile for the lessor including the lessor credentials, the profile generated using a machine learning model trained with data associated with the lessor obtained from at least one of past lease contracts of the lessor, public records, or onboarding information.

In Example 16, the subject matter of Examples 14-15 includes, wherein the rental space information corresponds to information collected during a registration of the physical rental space at a financial institution and stored at the data storage.

In Example 17, the subject matter of Examples 14-16 includes, instructions that cause the at least one processor to: before auto-populate the lease application: receive, at the wallet management system, from the second mobile wallet application, lessee credentials for authentication; and authenticate the lessee based on the lessee credentials.

In Example 18, the subject matter of Example 17 includes, wherein the lessee credentials include at least one of a one-time password, a personal identifier number (PIN), or a biometric feature.

In Example 19, the subject matter of Examples 14-18 includes, instructions that cause the at least one processor to: receive, at the wallet management system, from the first mobile wallet application, a signature request for a signature of the lessee in a lease contract corresponding to the lease application and; send the signature request to the second mobile wallet application; receive the lease contract including the signature of the lessee from the second mobile wallet application; and send the lease contract including the signature of the lessee to the first mobile wallet application.

In Example 20, the subject matter of Example 19 includes, instructions that cause the at least one processor to: receive, at the wallet management system, from the first mobile wallet application, a payment request for the lease contract; identify, at the wallet management system, that the payment request corresponds to a lease transaction; and disburse, in response to identify that the payment request corresponds to the lease transaction, at least one of: funds of a demand deposit account (DDA) of the lessee to the first mobile wallet application, the DDA linked to the wallet management system, the funds corresponding to a payment of the lease contract; cryptocurrency, the cryptocurrency corresponding to the payment of the lease contract; or a microloan for the lessee from a financial institution corresponding to the wallet management system, the microloan corresponding to the payment of the lease contract.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

1. A method comprising:
receiving, at a wallet management system, from a first mobile wallet application executed at a first mobile computing device of a lessor, lessor credentials of the lessor associated with a lease application, and a request for lessee information corresponding to a lessee for completing the lease application, the lease application corresponding to a physical rental space;
authenticating, using the wallet management system, the lessor based on the lessor credentials, the authenticating including:
verifying at least one of an Open Authorization (OAuth) token or a digital signature; and
issuing an access token that permits interaction with the first mobile wallet application;
obtaining, in response to authenticating the lessor, from a data storage, rental space information of the physical rental space;
verifying, using the wallet management system, that the physical rental space is owned by the lessor based on the rental space information;
retrieving, in response to authenticating the lessor and verifying that the physical rental space is owned by the lessor, the lessee information from a second mobile wallet application executed at a second mobile computing device of the lessee, the retrieving including:
transmitting, by the wallet management system through a secure application programming interface, to the second mobile wallet application, a data request for the lessee information and lessee credentials;
receiving, by the wallet management system through the secure application programming interface, the lessee information and the lessee credentials from the second mobile wallet application;
authenticating, by the wallet management system, the lessee based on the lessee credentials; and
enforcing, by the wallet management system, a stored permission scope controlling access to the lessee information;
auto-populating the lease application with the lessee information, the auto-populating including:
mapping respective data fields of the lessee information to corresponding placeholders in a predefined lease-application template; and
generating the auto-populated lease application as a digital document; and
sending, to the first mobile wallet application, the auto-populated lease application.

2. The method of claim 1, wherein the first mobile wallet application stores a profile for the lessor including the lessor credentials, the profile generated using a machine learning model trained with data associated with the lessor obtained from at least one of past lease contracts of the lessor, public records, or onboarding information.

3. The method of claim 1, wherein the rental space information corresponds to information collected during a registration of the physical rental space at a financial institution and stored at the data storage.

4. (canceled)

5. The method of claim 1, wherein the lessee credentials include at least one of a one-time password, a personal identifier number (PIN), or a biometric feature.

6. The method of claim 1, further comprising:
receiving, at the wallet management system, from the first mobile wallet application, a signature request for a signature of the lessee in a lease contract corresponding to the lease application;
sending the signature request to the second mobile wallet application;
receiving the lease contract including the signature of the lessee from the second mobile wallet application; and
sending the lease contract including the signature of the lessee to the first mobile wallet application.

7. The method of claim 6, further comprising:
receiving, at the wallet management system, from the first mobile wallet application, a payment request for the lease contract;
identifying, at the wallet management system, that the payment request corresponds to a lease transaction; and
in response to identifying that the payment request corresponds to the lease transaction, disbursing at least one of:
funds of a demand deposit account (DDA) of the lessee to the first mobile wallet application, the DDA linked to the wallet management system, the funds corresponding to a payment of the lease contract;
cryptocurrency, the cryptocurrency corresponding to the payment of the lease contract; or
a microloan for the lessee from a financial institution corresponding to the wallet management system, the microloan corresponding to the payment of the lease contract.

8. The method of claim 6, further comprising:
receiving, at the wallet management system, from the first mobile wallet application, a payment request for the lease contract;
identifying, at the wallet management system, that the payment request corresponds to a lease transaction; and
in response to identifying that the payment request corresponds to the lease transaction:
establishing a microloan for the lessee at a financial institution, the microloan corresponding to a payment of the lease transaction;
sending, using the wallet management system, funds of the microloan to an account of the lessor linked to the first mobile wallet application; and
paying off the microloan with a demand deposit account (DDA) of the lessee for building credit score of the lessee, the DDA linked to the wallet management system.

9. A method comprising:
initiating a near field communication (NFC) circuitry on a first mobile computing device of a lessor, the first mobile computing device including a first mobile wallet application;
sending lessor credentials of the lessor associated with a lease application for authentication and a data request for lessee data for completing the lease application;
receiving, via the NFC circuitry, from a second mobile computing device of a lessee, lessee credentials of the lessee and the lease application filled with the lessee data;
sending, by the first mobile computing device, the lessee credentials to a mobile wallet provider associated with the first mobile wallet application;
receiving, at the first mobile computing device from the mobile wallet provider, an approval of the lessee credentials for the lease application; and
sending, in response to receiving the approval of the lessee credentials for the lease application, a request for signing a lease contract corresponding to the lease application to the second mobile computing device.

10. The method of claim 9, further comprising:
sending, via the NFC circuitry, to the second mobile computing device, a payment request for the lease contract; and
receiving, in response to the payment request, at the first mobile wallet application from a second mobile wallet application associated with the second mobile computing device:
a cryptocurrency amount;
a monetary value of a first demand deposit account (DDA) of the lessee; or
funds of a microloan linked to the second mobile wallet application.

11. The method of claim 9, wherein the lease application corresponds to a physical rental space.

12. The method of claim 9, further comprising:
generating, using a machine learning model, a profile for the lessor including the lessor credentials, the machine learning model trained with data associated with the lessor obtained from at least one of past lease contracts of the lessor, public records, or onboarding information; and
storing the profile for the lessor at the first mobile wallet application.

13. The method of claim 9, wherein the lessee credentials include at least one of a one-time password, a personal identifier number (PIN), or a biometric feature.

14. A lease management system, the system comprising at least one processor; and
memory including instructions that, when executed by the at least one processor, cause the at least one processor to perform operations to:
receive, at a wallet management system, from a first mobile wallet application executed at a first mobile computing device of a lessor, lessor credentials of the lessor associated with a lease application, and a request for lessee information corresponding to a lessee for completing the lease application, the lease application corresponding to a physical rental space;
authenticate, using the wallet management system, the lessor based on the lessor credentials, the authenticating including operations to:
verify at least one of an Open Authorization (OAuth) token or a digital signature; and
issue an access token that permits interaction with the first mobile wallet application;
obtain, in response to authenticating the lessor, from a data storage, rental space information of the physical rental space;
verify, using the wallet management system, that the physical rental space is owned by the lessor based on the rental space information;
retrieve, in response to authenticating the lessor and verifying that the physical rental space is owned by the lessor, the lessee information from a second mobile wallet application executed at a second mobile computing device of the lessee, the retrieving including operations to:
transmit, by the wallet management system through a secure application programming interface, to the second mobile wallet application, a data request for the lessee information and lessee credentials;
receive, by the wallet management system through the secure application programming interface, the lessee information and the lessee credentials from the second mobile wallet application;
authenticate, by the wallet management system, the lessee based on the lessee credentials; and
enforce, by the wallet management system, a stored permission scope controlling access to the lessee information;
auto-populate the lease application with the lessee information, the auto-populating including operations to:
map respective data fields of the lessee information to corresponding placeholders in a predefined lease-application template; and
generate the auto-populated lease application as a digital document; and
send, to the first mobile wallet application, the auto-populated lease application.

15. The lease management system of claim 14, wherein the first mobile wallet application stores a profile for the lessor including the lessor credentials for authentication of the lessor, the profile generated using a machine learning model trained with data associated with the lessor obtained from at least one of past lease contracts of the lessor, public records, or onboarding information.

16. The lease management system of claim 14, wherein the rental space information corresponds to information collected during a registration of the physical rental space at a financial institution and stored at the data storage.

17. (canceled)

18. The lease management system of claim 14, wherein the lessee credentials include at least one of a one-time password, a personal identifier number (PIN), or a biometric feature.

19. The lease management system of claim 14, further comprising instructions that cause the at least one processor to:
receive, at the wallet management system, from the first mobile wallet application, a signature request for a signature of the lessee in a lease contract corresponding to the lease application;
send the signature request to the second mobile wallet application;
receive the lease contract including the signature of the lessee from the second mobile wallet application; and
send the lease contract including the signature of the lessee to the first mobile wallet application.

20. The lease management system of claim 19, further comprising instructions that cause the at least one processor to:
receive, at the wallet management system, from the first mobile wallet application, a payment request for the lease contract;
identify, at the wallet management system, that the payment request corresponds to a lease transaction; and
disburse, in response to identify that the payment request corresponds to the lease transaction, at least one of:
funds of a demand deposit account (DDA) of the lessee to the first mobile wallet application, the DDA linked to the wallet management system, the funds corresponding to a payment of the lease contract;
cryptocurrency, the cryptocurrency corresponding to the payment of the lease contract; or
a microloan for the lessee from a financial institution corresponding to the wallet management system, the microloan corresponding to the payment of the lease contract.
